(19) United States
(12) Patent Application Publication
(10) Pub. No.: US 2025/0391608 A1
(43) Pub. Date: Dec. 25, 2025

(54) MULTILAYER CERAMIC CAPACITOR

(71) Applicant: SAMSUNG ELECTRO-MECHANICS CO., LTD., Suwon-si (KR)

(72) Inventors: Ban Seok Choi, Suwon-si (KR); Myunghyun Jo, Suwon-si (KR); Eunchae Park, Suwon-si (KR); Myungsik Kim, Suwon-si (KR); Geumhee Yun, Suwon-si (KR)

(73) Assignee: SAMSUNG ELECTRO-MECHANICS CO., LTD., Suwon-si (KR)

(21) Appl. No.: 19/029,648

(22) Filed: Jan. 17, 2025

(30) Foreign Application Priority Data
Jun. 25, 2024 (KR) 10-2024-0083060

(51) Int. Cl. H01G 4/224; H01G 4/005; H01G 4/12; H01G 4/248; H01G 4/30

(52) U.S. Cl. CPC H01G 4/224; H01G 4/005; H01G 4/12; H01G 4/248; H01G 4/30

(57) ABSTRACT

A multilayer ceramic capacitor including: a dielectric layer; a first internal electrode and a second internal electrode facing each other with the dielectric layer interposed therebetween; and a first cover layer disposed over at least one of the first internal electrode and the second internal electrode, wherein the first cover layer is divided into a center area and a side area disposed outside the center area, and the side area has a surface inclined downward at an inclination of 18° or more and 20° or less with respect to a surface of the center area.

### CROSS-REFERENCE TO RELATED APPLICATION

This application claims priority to and the benefit of Korean Patent Application No. 10-2024-0083060 filed in the Korean Intellectual Property Office on Jun. 25, 2024, the entire contents of which are incorporated herein by reference.

### BACKGROUND

### (a) Technical Field

The present disclosure relates to a multilayer ceramic capacitor.

### (b) Description of the Related Art

A multilayer ceramic capacitor (MLCC), one of the multi-layered electronic components, is a chip-type capacitor that is mounted on printed circuit boards of various electronic products such as image devices (OLED and LED), computers, smartphones, and mobile phones to accumulate charges and release them when necessary.

The multilayer ceramic capacitor may be used as a component of various electronic devices due to its small size, high capacity, and easy mounting. As various electronic devices such as computers and mobile devices become smaller and have higher power, the demand for high capacity and miniaturization of multilayer ceramic capacitors is increasing.

As the multilayer ceramic capacitor becomes smaller, moisture permeation from the outside to the internal electrode becomes easier, and thus the possibility of defects in the multilayer ceramic capacitor increases.

Particularly, a moisture penetration path may easily occur from the edge of the ceramic main body to the end portion of the internal electrode, and a method to block this moisture penetration path is needed.

### SUMMARY

An aspect of an embodiment is to provide a multilayer ceramic capacitor that may improve moisture resistance reliability by blocking a moisture penetration path.

An embodiment provides a multilayer ceramic capacitor including: a dielectric layer; a first internal electrode and a second internal electrode facing each other with the dielectric layer interposed therebetween; and a first cover layer disposed over at least one of the first internal electrode and the second internal electrode. The first cover layer includes a center area and a side area disposed outside of the center area, and the side area has a surface inclined downward at an inclination of 18° or more and 20° or less with respect to a surface of the center area.

The side area may be disposed to surround the center area.

The multilayer ceramic capacitor may include an active area, the first internal electrode and the second internal electrode may overlap each other in the active area, and the center area may be disposed over the active area.

In addition, the multilayer ceramic capacitor may further include a margin area, the margin area may surround the active area, and the side area may be disposed over the margin area.

The center area may not overlap the margin area, and the side area may not overlap the active area.

The surface of the side area is inclined with respect to an extension line of an uppermost internal electrode among the first internal electrode and the second internal electrode.

The multilayer ceramic capacitor may further include a second cover layer disposed on the dielectric layer, the first internal electrode, and the second internal electrode. The dielectric layer, the first internal electrode, and the second internal electrode may be between the first cover layer and the second cover layer. A portion of the second cover layer overlapping the side area may be at the inclination with respect to a line parallel to the side area.

Another aspect of the application relates to a method of manufacturing the multilayer ceramic capacitor disclosed herein. The method includes applying a paste on a film to form a dielectric green sheet, wherein the paste includes polyvinyl butyral that has a glass transition temperature of 80° C. or higher and 90° C. or lower.

The paste may further include a ceramic, and the paste may include polyvinyl butyral in an amount of 10 wt % or more and 30 wt % or less based on a weight of the ceramic.

The method of claim 8 may further include applying a conductive paste including a conductive metal onto a surface of the dielectric green sheet, stacking a plurality of the dielectric green sheets on which the conductive paste was applied to form a laminate, and sintering the laminate to form the dielectric layer, the first internal electrode, and the second electrode.

According to at least one multilayer ceramic capacitor in the embodiment, at least a portion of the edge of the ceramic main body can be inclined at a predetermined angle, thereby blocking the moisture penetration path, thereby improving moisture resistance reliability.

### BRIEF DESCRIPTION OF THE DRAWINGS

FIG. 1 illustrates a perspective view of a multilayer ceramic capacitor according to an embodiment.

FIG. 2 illustrates a perspective view of a ceramic main body separated from the multilayer ceramic capacitor illustrated in FIG. 1.

FIG. 3 illustrates a perspective view of a first cover layer separated from the ceramic main body illustrated in FIG. 2.

FIG. 4 illustrates a cross-sectional view taken along line IV-IV′ in FIG. 1.

FIG. 5 illustrates a cross-sectional view of a ceramic main body separated from the multilayer ceramic capacitor illustrated in FIG. 4.

FIG. 6 illustrates an exploded perspective view of a portion of the ceramic main body.

FIG. 7 illustrates an enlarged view of portion VII illustrated in FIG. 5.

FIG. 8 illustrates an enlarged view of portion VIII illustrated in FIG. 5.

FIG. 9 illustrates a plurality of dielectric green sheets.

FIG. 10 illustrates a stacked structure of a ceramic main body using the dielectric green sheet illustrated in FIG. 9.

### DETAILED DESCRIPTION

The present disclosure will be described more fully hereinafter with reference to the accompanying drawings, in which embodiments of the disclosure are shown. In order to clearly describe the present disclosure, parts that are irrelevant to the description are omitted, and identical or similar constituent elements throughout the specification are denoted by the same reference numerals. In addition, some constituent elements are exaggerated, omitted, or briefly illustrated in the added drawings, and sizes of the respective constituent elements do not reflect the actual sizes.

The accompanying drawings are provided only in order to allow embodiments disclosed in the present specification to be easily understood and are not to be interpreted as limiting the spirit disclosed in the present specification, and it is to be understood that the present disclosure includes all modifications, equivalents, and substitutions without departing from the scope and spirit of the present disclosure.

Terms including an ordinal number, such as first, second, etc., may be used to describe various elements, but the elements are not limited by the terms. These terms are only used to differentiate one constituent element from another.

It will be understood that when an element such as a layer, film, region, area, substrate, plate, or the like is referred to as being “on” another element, it can be directly on the other element or intervening elements may also be present. In contrast, when an element is referred to as being “directly on” another element, there are no intervening elements present. Further, in the specification, the word “on” or “above” means disposed on or below the object portion, and does not necessarily mean disposed on the upper side of the object portion based on a gravitational direction.

Throughout the specification, it should be understood that the term “include”, “comprise”, “have”, or “configure” indicates that a feature, a number, a step, an operation, a constituent element, a part, or a combination thereof described in the specification is present, but does not exclude a possibility of presence or addition of one or more other features, numbers, steps, operations, constituent elements, parts, or combinations, in advance. Unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Furthermore, throughout the specification, “connected” does not only mean when two or more elements are directly connected, but also when two or more elements are indirectly connected through other elements, and when they are physically connected or electrically connected, and further, it may be referred to by different names depending on a position or function, and may also be referred to as a case respective parts that are substantially integrated are linked to each other.

In the present specification, in describing the multilayer ceramic capacitor, a direction in which the main components of the multilayer ceramic capacitor are stacked is defined as a ‘stacking direction’, but this may also be a ‘thickness direction’. In addition, a direction parallel to the plane perpendicular to the stacking direction can be defined as a ‘planar direction’.

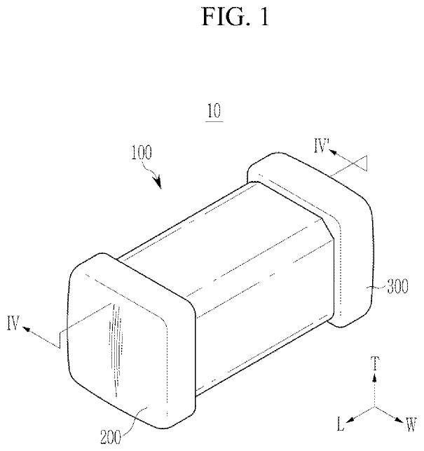

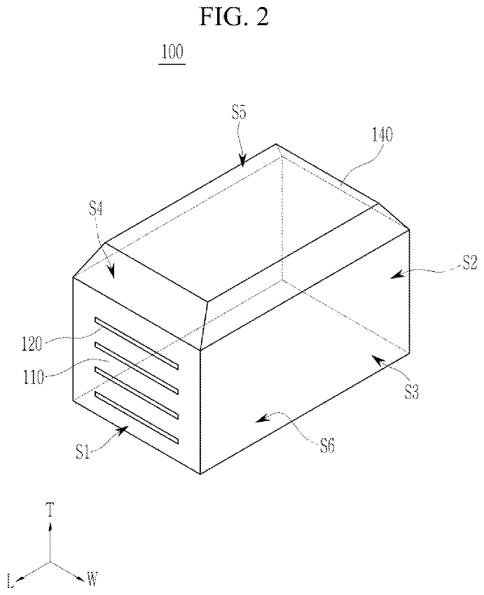

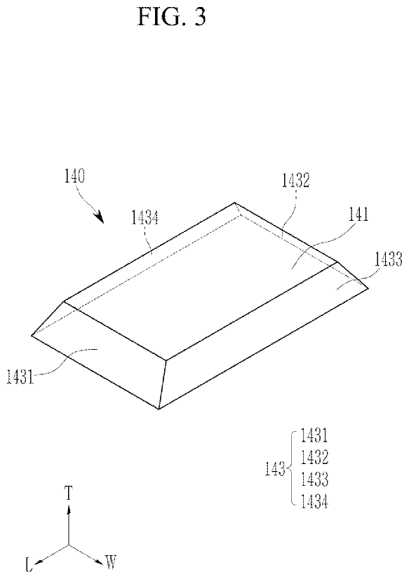

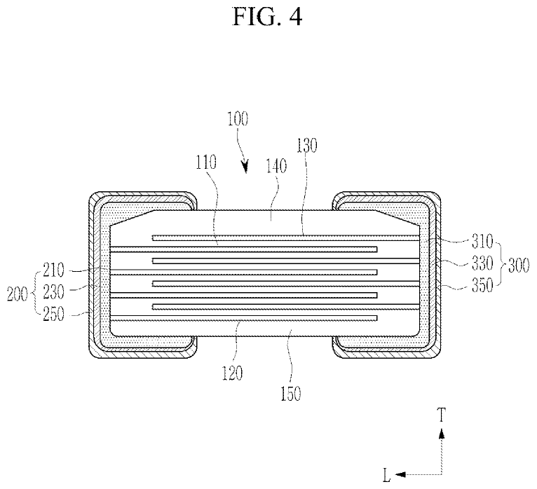

FIG. 1 schematically illustrates a perspective view of a multilayer ceramic capacitor according to an embodiment. FIG. 2 illustrates a perspective view of a ceramic main body separated from the multilayer ceramic capacitor illustrated in FIG. 1. FIG. 3 illustrates a perspective view of a first cover layer separated from the ceramic main body illustrated in FIG. 2. FIG. 4 illustrates a cross-sectional view taken along line IV-IV′ in FIG. 1.

Referring to FIG. 1, FIG. 2, FIG. 3, and FIG. 4, the multilayer ceramic capacitor according to the present embodiment includes a ceramic main body 100, a first external electrode 200, and a second external electrode 300.

First, when directions are defined to clearly described the present embodiment, an L-axis, a W-axis, and a T-axis shown in the drawings indicate axes respectively representing a length direction, a width direction, and a thickness direction of the ceramic main body 100.

The thickness direction (T-axis direction) may be a direction perpendicular to a wide surface (main surface) of sheet-shaped components. For example, the thickness direction (T-axis direction) may be used as the same concept as the direction in which the components of the ceramic main body 100 are stacked.

The length direction (L-axis direction) is a direction parallel to the wide surface (main surface) of the sheet-shaped components, and may be a direction that intersects (or is perpendicular to) the thickness direction (T-axis direction). For example, the length direction (L-axis direction) may be a direction in which the first external electrode 200 and the second external electrode 300 face each other.

The width direction (W-axis direction) is a direction parallel to the wide surface (main surface) of the sheet-shaped components, and may be a direction that simultaneously intersects (or is perpendicular to) the thickness direction (T-axis direction) and the length direction (L-axis direction).

The ceramic main body 100 may have a substantially hexahedral shape, but the present embodiment is not limited thereto. Due to contraction during sintering, the ceramic main body 100 may have a substantially hexahedral shape, although not a perfect hexahedral shape. For example, the ceramic main body 100 has a substantially rectangular hexahedral shape, but portions corresponding to corners or vertices thereof may have a rounded shape, and the outer portion of the upper portion thereof may have a shape that is inclined downward.

In the present embodiment, for convenience of description, surfaces facing each other in the length direction (L-axis direction) are defined as a first surface S1 and a second surface S2, surfaces facing each other in the width direction (W-axis direction) and connecting the first surface S1 and the second surface S2 are defined as a third surface S3 and a fourth surface S4, and surfaces facing each other in the thickness direction (T-axis direction) and connecting the first surface S1 and the second surface S2 are defined as a fifth surface S5 and a sixth surface S6.

In addition, in the present embodiment, the fifth and sixth surfaces will be defined as upper and lower surfaces. In this case, the lower surface side may be a direction in which the lower surface side is mounted on the substrate.

Accordingly, the first direction in which the first surface S1 and the second surface S2 face each other may be the length direction (L-axis direction), and the second direction and the third direction that are perpendicular to the first direction and perpendicular to each other may be the thickness direction (T-axis direction) and the width direction (W-axis direction), respectively. In another example, the first direction in which the first surface S1 and the second surface S2 face each other may be the length direction (L-axis direction), and the second direction and the third direction that are perpendicular to the first direction and perpendicular to each other may be the width direction (W-axis direction) and the thickness direction (T-axis direction), respectively.

A length of the ceramic main body 100 may mean, based on an optical microscope or scanning electron microscope (SEM) photograph of a cross-section in the length direction (L-axis direction)-the thickness direction (T-axis direction) at a center of the width direction (W-axis direction) of the ceramic main body 100, a maximum value of lengths of a plurality of line segments that connect two outermost boundary lines facing each other in the length direction (L-axis direction) of the ceramic main body 100 shown in the above cross-sectional photograph and are parallel to the length direction (L-axis direction). Meanwhile, the length of the ceramic main body 100 may mean a minimum value of lengths of a plurality of line segments that connect two outermost boundary lines facing each other in the length direction (L-axis direction) of the ceramic main body 100 shown in the above cross-sectional photograph and are parallel to the length direction (L-axis direction). On the other hand, the length of the ceramic main body 100 may mean an arithmetic average value of lengths of at least two of a plurality of line segments that connect two outermost boundary lines facing each other in the length direction (L-axis direction) of the ceramic main body 100 shown in the above cross-sectional photograph and are parallel to the length direction (L-axis direction).

A thickness of the ceramic main body 100 may mean, based on an optical microscope or scanning electron microscope (microscope SEM) photograph of a cross-section in the length direction (L-axis direction)-the thickness direction (T-axis direction) at a center of the width direction (W-axis direction) of the ceramic main body 100, a maximum value of lengths of a plurality of line segments that connect two outermost boundary lines facing each other in the thickness direction (T-axis direction) of the ceramic main body 100 shown in the above cross-sectional photograph and are parallel to the thickness direction (T-axis direction). Meanwhile, the thickness of the ceramic main body 100 may mean a minimum value of lengths of a plurality of line segments that connect two outermost boundary lines facing each other in the thickness direction (T-axis direction) of the ceramic main body 100 shown in the above cross-sectional photograph and are parallel to the thickness direction (T-axis direction). On the other hand, the thickness of the ceramic main body 100 may mean an arithmetic average value of lengths of at least two of a plurality of line segments that connect two outermost boundary lines facing each other in the thickness direction (T-axis direction) of the ceramic main body 100 shown in the above cross-sectional photograph and are parallel to the thickness direction (T-axis direction).

A width of the ceramic main body 100 may mean, based on an optical microscope or scanning electron microscope (microscope SEM) photograph of a cross-section in the length direction (L-axis direction)-the width direction (W-axis direction) at a center of the thickness direction (T-axis direction) of the ceramic main body 100, a maximum value of lengths of a plurality of line segments that connect two outermost boundary lines facing each other in the width direction (W-axis direction) of the ceramic main body 100 shown in the above cross-sectional photograph and are parallel to the width direction (W-axis direction). Meanwhile, the width of the ceramic main body 100 may mean a minimum value of lengths of a plurality of line segments that connect two outermost boundary lines facing each other in the width direction (W-axis direction) of the ceramic main body 100 shown in the above cross-sectional photograph and are parallel to the width direction (W-axis direction). On the other hand, the width of the ceramic main body 100 may mean an arithmetic average value of lengths of at least two of a plurality of line segments that connect outermost boundary lines facing each other in the width direction (W-axis direction) of the ceramic main body 100 shown in the above cross-sectional photograph and are parallel to the width direction (W-axis direction).

Meanwhile, the length, width, and thickness of the ceramic main body 100 may each be measured using a micrometer measurement method. The micrometer measurement method may be measured by setting the zero point with a micrometer with gauge repeatability and reproducibility (R&R), inserting the ceramic main body 100 according to the present embodiment between the tips of the micrometer, and turning the measurement lever of the micrometer. Meanwhile, when measuring the length of the ceramic main body 100 by the micrometer measurement method, the length of the ceramic main body 100 may mean a value measured once, or may mean an arithmetic average of values measured a plurality of times. This may be equally applied to measuring the width and thickness of the ceramic main body 100.

The ceramic main body 100 includes a dielectric layer 110, a first internal electrode 120, a second internal electrode 130, a first cover layer 140, and a second cover layer 150.

The dielectric layer 110 may be stacked in the thickness direction (T-axis direction) of the ceramic main body 100. The boundaries between the dielectric layers 110 may be unclear. That is, a plurality of dielectric layers 110 may be viewed as an integral structure. For example, the boundary between the dielectric layers 110 may be so unclear that it is difficult to confirm the boundary without using a scanning electron microscope (SEM).

The dielectric layer 110 may include a ceramic material with a high dielectric constant. For example, the ceramic material may include a dielectric ceramic including a component such as BaTiO₃, CaTiO₃, SrTiO₃, or CaZrO₃. In addition, an auxiliary component such as a manganese (Mn) compound, an iron (Fe) compound, a chromium (Cr) compound, a cobalt (Co) compound, or a nickel (Ni) compound may be further included in the component. For example, the dielectric layer may include (Ba₁₋ₓCaₓ)TiO₃, Ba(Ti_{1-y}Ca_{y})O₃, (Bahd 1-xCaₓ)(Ti_{1-y}Zr_{y})O₃, or Ba(Ti_{1-y}Zr_{y})O₃, in which calcium (Ca), zirconium (Zr), and the like are partially dissolved in BaTiO₃, but the present disclosure is not limited thereto.

In addition, the dielectric layer 110 may further include one or more of a ceramic additive, an organic solvent, a plasticizer, a binder, and a dispersant. For example, the ceramic additive may include a transition metal oxide, a carbide, a rare earth element, magnesium (Mg), or aluminum (Al).

In addition, a binder may be included in the slurry for forming the dielectric layer 110. The binder is used to provide plasticity or shape retention. Since the binder is decomposed during the sintering process, the binder may not remain in the dielectric layer 110 after sintering.

The first internal electrode 120 and the second internal electrode 130 may be alternately stacked with the dielectric layer 110 interposed therebetween. That is, the structure of the first internal electrode/the dielectric layer/the second internal electrode/the dielectric layer may be repeatedly disposed inside the ceramic main body 100. For example, the internal electrode closest to the fifth surface S5 of the ceramic main body 100 may be the first internal electrode 120, and the internal electrode closest to the sixth surface S6 thereof may be the second internal electrode 130. As another example, the internal electrode closest to the fifth surface S5 of the ceramic main body 100 may be second internal electrode 130, and the internal electrode closest to the sixth surface S6 thereof may be the first internal electrode 120.

The first internal electrode 120 and the second internal electrode 130 have different polarities. The first internal electrode 120 and the second internal electrode 130 may be electrically insulated from each other by the dielectric layer 110 disposed therebetween.

The first internal electrode 120 and the second internal electrode 130 may be disposed to be offset from each other in the length direction (L-axis direction) with the dielectric layer 110 interposed therebetween. That is, the first internal electrode 120 and the second internal electrode 130 may be disposed so that portions of the first internal electrode 120 and the second internal electrode 130 overlap each other in the thickness direction (T-axis direction), and the other portions does not overlap each other. One end portion of the first internal electrode 120 may be exposed through the first surface S1 of the ceramic main body 100. In addition one end portion of the second internal electrode 130 may be exposed through the second surface S2 of the ceramic main body 100. An end portion of the first internal electrode 120 exposed from the first surface S1 of the ceramic main body 100 may be connected to the first external electrode 200. In addition, an end portion of the second internal electrode 130 exposed from the second surface S2 of the ceramic main body 100 may be connected to the second external electrode 300.

The first internal electrode 120 and the second internal electrode may be formed by printing a conductive paste on the surface of the dielectric layer 110. In this case, the conductive paste may include a conductive metal. For example, an internal electrode may be formed by printing a conductive paste containing nickel (Ni) or a nickel (Ni) alloy on the surface of the dielectric green sheet 500 using screen printing or gravure printing. However, the present embodiment is not limited thereto.

For example, the average thickness of the first internal electrode 120 and the second internal electrode 130 may be approximately 0.1 μm or more and 2 μm or less.

Here, the thickness of the internal electrode may mean the average thickness of one internal electrode disposed between two dielectric layers. The average thickness of the internal electrode may be an arithmetic average of values of the thickness of one internal electrode shown in the above-described cross-sectional photograph measured at 30 points with equal intervals in the length direction (L-axis direction), based on the scanning electron microscope (SEM) photograph of the 10,000 magnification for a cross section in the length direction (L-axis direction)-thickness direction (T-axis direction) at the center of the ceramic main body 100 in the width direction (W-axis direction).

When a voltage is applied to the first external electrode 200 and the second external electrode 300, charges are accumulated between the first internal electrode 120 and the second internal electrode 130 adjacent to each other. That is, capacitance may be obtained between the first internal electrode 120 electrically connected to the first external electrode 200 and the second internal electrode 130 electrically connected to the second external electrode 300. The capacitance of the multilayer ceramic capacitor 10 is proportional to the overlapping area of the first internal electrode 120 and the second internal electrode 130 overlapping each other along the thickness direction (T-axis direction).

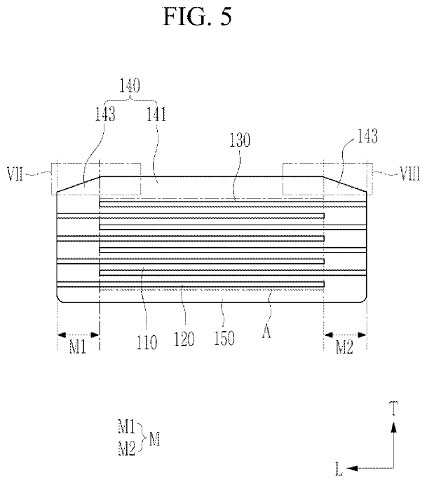

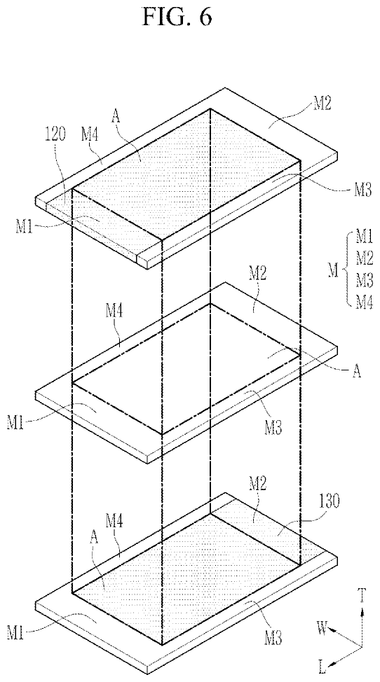

FIG. 5 illustrates a cross-sectional view of the ceramic main body 100 separated from the multilayer ceramic capacitor illustrated in FIG. 4. FIG. 6 illustrates an exploded perspective view of a portion of the ceramic main body separated.

Referring to FIG. 5 and FIG. 6, the ceramic main body 100 may be divided into an active area A and a margin area M based on an area in which charges are substantially formed.

The active area A is a portion in which charges are accumulated in the ceramic main body. The active area A may be an area in which the first internal electrode 120 and the second internal electrode 130 overlap each other based on the thickness direction (T-axis direction) of the ceramic main body 100. The margin area M may be an area in which the first internal electrode 120 and the second internal electrode 130 do not overlap each other. In another aspect, the margin area M may be an area between the active area A and the end surface of the ceramic main body 100. The margin area M includes a first margin area M1 that is an area between the active area A and the first surface S1, a second margin area M2 that is an area between the active area A and the second surface S2, a third margin area M3 that is an area between the active area A and the third surface S3, and a fourth margin area M4 that is an area between the active area A and the fourth surface S4.

A plurality of first internal electrodes 120 and second internal electrodes 130 overlap in the active area A, while a plurality of first internal electrodes 120 are disposed in the first margin area M1 and a plurality of second internal electrodes 130 are disposed in the second margin area M2. In addition, neither the first internal electrode 120 nor the second internal electrode 130 is not disposed in the third margin area M3 and the fourth margin area M4.

While the dielectric is made of a ceramic material, the first internal electrode 120 and the second internal electrode 130 are made of a metal material, so there is a difference in shrinkage rate when pressure is applied, and thus an inclination may be formed at the edge portion of the first cover layer 140 during sintering.

Referring to FIG. 5, a first cover layer 140 and a second cover layer 150 may be disposed over and under the active area A and the margin area M in the thickness direction (T-axis direction), respectively. The first cover layer 140 may be disposed between the fifth surface S5 of the ceramic main body 100 and the internal electrode closest thereto. The second cover layer 150 may be disposed between the sixth surface S6 of the ceramic main body 100 and the internal electrode closest thereto.

That is, the first cover layer 140 may be disposed over the internal electrode (hereinafter, referred to as a “topmost internal electrode”) disposed at the uppermost end in the thickness direction (T-axis direction) among the internal electrodes. In addition, the second cover layer 150 may be disposed under the internal electrode (hereinafter, referred to as a “lowermost internal electrode”) disposed at the lowermost end in the thickness direction (T-axis direction) among the internal electrodes. The first cover layer 140 and the second cover layer 150 may have the same composition as that of the dielectric layer 110. The first cover layer 140 may be formed by stacking one or more other dielectric layers over the uppermost internal electrode and the dielectric layer parallel to the uppermost internal electrode. In addition, the second cover layer 150 may be formed by stacking one or more other dielectric layers under the lowermost internal electrode and the dielectric layer parallel to the lowermost internal electrode.

The first cover layer 140 and the second cover layer 150 may serve to prevent damage to the first internal electrode 120 and the second internal electrode 130 due to physical or chemical stress.

Referring to FIG. 3, the first cover layer 140 may be divided into a center area 141 and a side area 143.

The center area 141 is disposed in a center portion of the first cover layer 140. The center area 141 may be defined as a portion overlapping the active area A in the thickness direction (T-axis direction). A surface of the center area 141 may be substantially parallel to the first internal electrode 120 or the second internal electrode 130. That is, a portion of the center area 141 exposed to the fifth surface may be substantially parallel to the first internal electrode 120 or the second internal electrode 130.

The side area 143 is disposed outside the center area 141. The side area 143 is an edge portion of the first cover layer 140 and may be disposed to surround the center area 141. The side area 143 may be defined as a portion overlapping the margin area M in the thickness direction (T-axis direction). That is, referring to FIG. 3, the side area 143 includes a first side area 1431, which is an area between the center area 141 and the first surface S1, a second side area 1432, which is an area between the center area 141 and the second surface S2, a third side area 1433, which is an area between the center area 141 and the third surface S3, and a fourth side area 1434, which is an area between the center area 141 and the fourth surface S4. The first side area 1431, the second side area 1432, the third side area 1433, and the fourth side area 1434 respectively overlap the first margin area M1, the second margin area M2, the third margin area M3, and the fourth margin area M4 in the thickness direction (T-axis direction).

In other words, in the thickness direction (T-axis direction), the center area 141 may be disposed over the active area A. The center area 141 may not overlap the margin area M. In addition, in the thickness direction (T-axis direction), the side area 143 may be disposed over the margin area M. The side area 143 may not overlap the active area A.

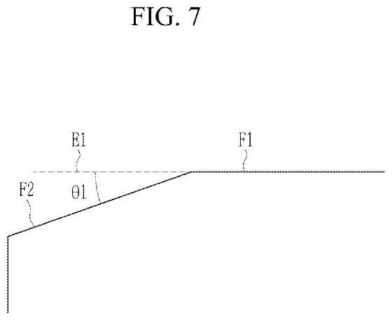

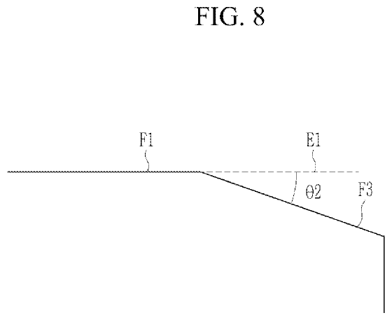

FIG. 7 illustrates an enlarged view of portion VII illustrated in FIG. 5. FIG. 8 illustrates an enlarged view of portion VIII illustrated in FIG. 5.

Referring to FIG. 2, FIG. 3, FIG. 4, FIG. 5, FIG. 7, and FIG. 8, the surface of the side area 143 is inclined in the direction of the sixth surface S6 with respect to the surface of the center area 141. That is, when a virtual extension line E1 extending from a surface F1 of the center area 141 is drawn, surfaces F2 and F3 may be formed to intersect the virtual extension line E1.

A first external angle 61 is an angle formed by the virtual extension line E1 and the surface F2 of the first side area 1431. A second external angle 62 is an angle formed by the virtual extension line E1 and the surface F3 of the second side area 1432.

For example, the surface F2 of the first side area may be defined as a line connecting the end point of the center area and the end point of the first surface. In this case, the end point of the center area may be defined as a point at which the center area F1 extends parallel to the first internal electrode 120 or the second internal electrode 130 and then begins to be inclined in the direction of the sixth surface S6, and the end point of the first surface may be defined as a point at which the first surface S1 extends parallel to the thickness direction (T-axis direction) and then begins to be inclined in the direction of the second surface S2.

In addition, the surface F3 of the second side area may be defined as a line connecting the end point of the center area and the end point of the second surface. In this case, the end point of the center area may be defined as a point at which the center area F1 extends parallel to the first internal electrode 120 or the second internal electrode 130 and then begins to be inclined in the direction of the sixth surface S6, and the end point of the second surface may be defined as a point at which the second surface S2 extends parallel to the thickness direction (T-axis direction) and then begins to be inclined in the direction of the first surface S1.

In other words, the first exterior angle 61 may refer to an angle formed by an extension line of the internal electrode disposed at the top among the internal electrodes shown in the above-described cross-sectional photograph and the surface of the first side area 1431. In addition, the second exterior angle 62 may refer to an angle formed by the internal electrode disposed at the top among the internal electrodes shown in the above-described cross-sectional photograph and the surface of the second side area 1432.

The first exterior angle θ1 may be 18° or more and 20° or less. In addition, the second exterior angle θ2 may be 18° or more and 20° or less. A third exterior angle, which is an angle formed by the surface of the third side area and the surface of the center area, may be 18° or more and 20° or less. In addition, a fourth exterior angle, which is an angle formed by the surface of the fourth side area and the surface of the center area, may be 18° or more and 20° or less.

When the first exterior angle, the second exterior angle, the third exterior angle, and the fourth exterior angle are 18° or more and 20° or less, a moisture path that may be formed between the edge of the ceramic main body 100 and the internal electrode may be effectively blocked. Accordingly, moisture resistance reliability may be improved. The exterior angles may be measured using an optical microscope or a scanning electron microscope (SEM). Other methods and/or tools appreciated by one of ordinary skill in the art, even if not described in the present disclosure, may also be used.

The first external electrode 200 and the second external electrode 300 are disposed outside the ceramic main body 100. The first external electrode 200 is disposed on the first surface S1 of the ceramic main body 100 and may extend to the third surface S3, the fourth surface S4, the fifth surface S5, and the sixth surface S6.

The first external electrode 200 includes a first electrode layer 210 and a first conductive resin layer 230, and the second external electrode 300 includes a second electrode layer 310 and a second conductive resin layer 330.

The first electrode layer 210 and the second electrode layer 310 may include conductive metal and glass.

For example, the first electrode layer 210 and the second electrode layer 310 may include copper (Cu), a copper (Cu) alloy, nickel (Ni), silver (Ag), palladium (Pd), gold (Au), platinum (Pt), tin (Sn), tungsten (W), titanium (Ti), lead (Pb), an alloy thereof, or a combination thereof, as conductive metals.

For example, the first electrode layer 210 and the second electrode layer 310 may include a composition in which oxides are combined with glass. For example, it may be one or more of a silicon oxide, a boron oxide, an aluminum oxide, a transition metal oxide, an alkali metal oxide, and an alkaline earth metal oxide. The transition metal may be selected from the group consisting of zinc (Zn), titanium (Ti), copper (Cu), vanadium (V), manganese (Mn), iron (Fe), and nickel (Ni), the alkali metal may be selected from the group consisting of lithium (Li), sodium (Na), and potassium (K), and the alkaline earth metal may be one or more selected from the group consisting of magnesium (Mg), calcium (Ca), strontium (Sr), and barium (Ba).

The first conductive resin layer 230 and the second conductive resin layer 330 may include a resin and a conductive metal.

The resin included in the first conductive resin layer 230 and the second conductive resin layer 330 is not particularly limited as long as it may have bonding properties and impact absorption properties and may be mixed with conductive metal powder to make a paste. For example, the resins included in the first conductive resin layer 230 and the second conductive resin layer 330 may include a phenol resin, an acrylic resin, a silicone resin, epoxy resin, or a polyimide resin.

The conductive metal included in the first conductive resin layer 230 and the second conductive resin layer 330 serves to electrically connect the first electrode layer 210 and the second electrode layer 310. The conductive metal included in the first conductive resin layer 230 and the second conductive resin layer 330 may have a spherical shape, a flake shape, or a combination thereof.

The first external electrode 200 may include a first plating layer 250 disposed outside the first conductive resin layer 230, and the second external electrode 300 may include a second plating layer 350 disposed outside the second conductive resin layer 330.

The first plating layer 250 and the second plating layer 350 may include nickel (Ni), copper (Cu), tin (Sn), palladium (Pd), platinum (Pt), gold (Au), silver (Ag), tungsten (W), titanium (Ti), or lead (Pb), or an alloy thereof. For example, the first plating layer 250 and the second plating layer 350 may be a nickel (Ni) plating layer or a tin (Sn) plating layer, and may have a structure in which a nickel (Ni) plating layer and a tin (Sn) plating layer are sequentially stacked or a structure in which a tin (Sn) plating layer, a nickel (Ni) plating layer, and a tin (Sn) plating layer are sequentially stacked. In addition, the plating layer may include a plurality of nickel (Ni) plating layers and/or a plurality of tin (Sn) plating layers.

The first plating layer 250 and the second plating layer 350 may improve mounting properties, structural reliability, external durability, heat resistance, and equivalent series resistance (ESR) of the multilayer ceramic capacitor 10 with a substrate.

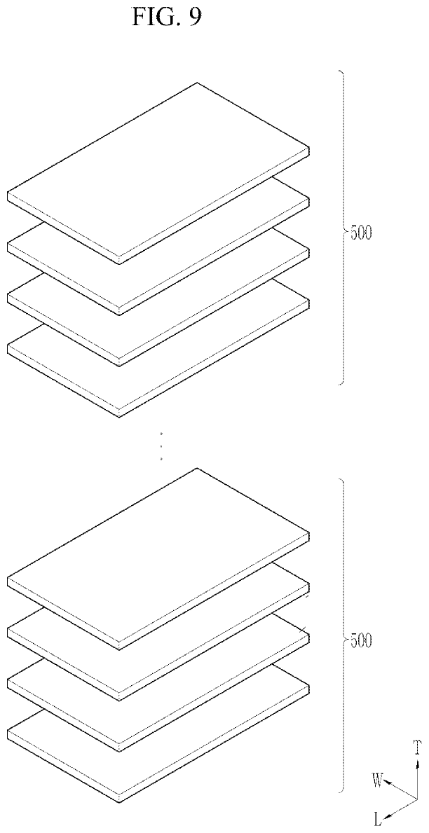

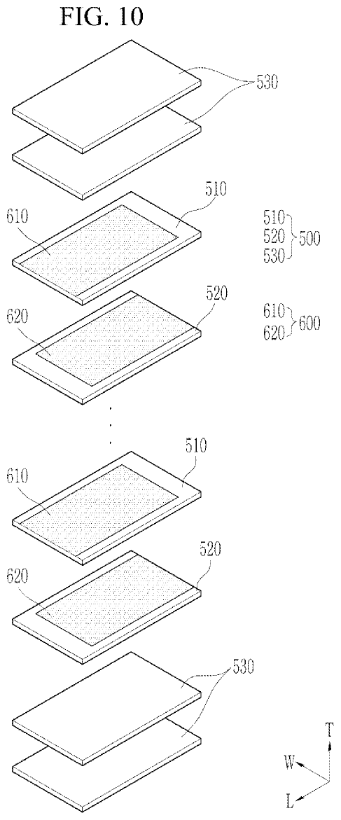

Hereinafter, a manufacturing method of the multilayer ceramic capacitor 10 according to the embodiment will be described with reference to FIG. 9 and FIG. 10.

FIG. 9 illustrates a plurality of dielectric green sheets. FIG. 10 illustrates a stacked structure of a ceramic main body using the dielectric green sheet illustrated in FIG. 9.

First, a dielectric paste for forming the plurality of dielectric green sheets 500 is prepared. The dielectric paste may include ceramic powder, ceramic additive, organic solvent, plasticizer, dispersant, and binder.

For example, the ceramic power may include a dielectric ceramic including a component such as BaTiO₃, CaTiO₃, SrTiO₃, or CaZrO₃. In addition, these components may further include auxiliary components such as an Mn compound, an Fe compound, a Cr compound, a Co compound, and an Ni compound. For example, (Ba₁₋ₓCaₓ)TiO₃, Ba(Ti_{1-y}Ca_{y})O₃, (Ba₁₋ₓCaₓ)(Ti_{1-y}Zr_{y})O₃, or Ba(Ti_{1-y}Zr_{y})O₃, in which Ca, Zr, and the like are partially dissolved in BaTiO₃-based dielectric ceramic, may be included.

For example, the ceramic additive may include a transition metal oxide, a transition metal carbide, a rare earth element, magnesium (Mg), aluminum (AI), and the like.

The organic solvent is not particularly limited, and may include, for example, butylcarbitol, acetone, toluene, ethyl acetate, and the like.

The binder may be a polyvinyl butyral (PVB) binder with a glass transition temperature (Tg) of 80° C. or higher and 90° C. or lower. For example, the binder may further include at least one of polyacrylic acid ester, polymethacrylic acid ester, polyvinyl alcohol, cellulose dielectric, polyethylene oxide, polyurethane, polyvinyl acetate, polyethylene, ethylene vinyl acetate copolymer, and polyvinyl chloride. The dielectric paste of the present embodiment may include a PVB binder with a glass transition temperature (Tg) of 80° C. to 90° C., and the weight thereof may be 10 wt % or more or more and 30 wt % or less based on the weight of ceramic in the dielectric paste.

The dielectric paste may be provided through a disintegration process so that the powders have uniform particles in the organic solvent. For example, ceramic powder, ceramic additive, organic solvent, plasticizer, dispersant, and binder may be filled in a hollow cylindrical disintegration mill, and an impeller provided in the disintegration mill may be rotated at a constant speed to disintegrate the powder by rotational force. In addition, a process of separating coarse particles may be performed, and a filtering process may be performed to remove foreign substances.

Referring to FIG. 9, the dielectric paste provided as described above is used to manufacture a plurality of dielectric green sheets 500 having a sheet shape of several μm thick using a doctor blade, screen printing method, or the like.

For example, the dielectric green sheet 500 may be manufactured by applying dielectric paste 76 to a certain thickness on a film, then performing a filtering process and a drying process, and then removing the film.

Referring to FIG. 10, a conductive paste layer 600 is formed on a surface of a portion of the dielectric green sheet 500. The conductive paste layer 600 becomes the first internal electrode 120 and the second internal electrode 130 after sintering. The conductive paste layer 600 may be formed by applying a conductive paste including a conductive metal onto the surface of the dielectric green sheet 500 using a method such as a doctor blade or a screen printing method. For example, the conductive metal may include a metal such as Ni, Cu, Ag, Pd, or Au, or an alloy thereof.

For example, the conductive paste may be applied on the dielectric green sheet 500 in two patterns. The conductive paste may be applied to a surface of a first dielectric green sheet 510 in a first pattern to form a first conductive paste layer 610. In addition, the conductive paste may be applied to a surface of a second dielectric green sheet 520 in a second pattern to form a second conductive paste layer 620.

The dielectric green sheet 500 is stacked to manufacture a dielectric green sheet laminate.

When the first dielectric green sheet 510 and the second dielectric green sheet 520 are alternately stacked, the first conductive paste layer 610 and the second conductive paste layer 620 may be aligned so that some portions overlap and other portions do not overlap. The first conductive paste layer 610 may be the first internal electrode 120 after sintering, and the second conductive paste layer 620 may be the second internal electrode 130 after sintering.

Referring to FIG. 10, a dielectric green sheet laminate is manufactured by laminating a dielectric green sheet. In this case, the first dielectric green sheet 510 and the second dielectric green sheet 520 allow the first conductive paste layer 610 and the second conductive paste layer to overlap, but at least some thereof are stacked so as not to overlap.

A third dielectric green sheet 530, in which a conductive paste layer is not formed, is stacked over the first dielectric green sheet 510 and under the second dielectric green sheet 520.

The dielectric green sheet laminate manufactured as described above is compressed. In this case, the side to which the pressure is applied is the upper surface of the ceramic main body 100, that is, the fifth surface S5.

In the step of stacking or compressing the dielectric green sheet laminate, flow of the dielectric green sheet may occur. Examples of the flow of the dielectric green sheet may be pore collapse, binder flow, and particle rearrangement. When the flow of the dielectric green sheet occurs, partial depression may occur in the first cover layer 140 of the dielectric green sheet laminate. The depression is caused by a difference in shrinkage rate between the internal electrode layer and the dielectric. Accordingly, a depression may occur in the side area 143 of the first cover layer 140 to form an inclination. In this case, when the PVB binder with a glass transition temperature (Tg) of 80° C. or more and 90° C. or less is included in the dielectric paste in an amount of 10 wt % or more and 30 wt % or less based on the weight of the ceramic, the first exterior angle θ1, the second exterior angle θ2, the third exterior angle, and the fourth exterior angle may be formed to be 18° or more and 20° or less, respectively.

Optionally, the dielectric green sheet laminate may be cut so that the first conductive paste layer 610 and the second conductive paste layer 620 are exposed through both cross-sections of the dielectric green sheet stack, respectively.

The dielectric green sheet laminate is sintered at a high temperature to manufacture the ceramic main body 100.

The first external electrode 200 is formed on the cross-section where the first internal electrode 120 of the ceramic main body 100 is exposed, and the second external electrode 300 is formed on the cross-section where the second internal electrode 130 thereof is exposed.

For example, the first external electrode 200 and the second external electrode 300 may be formed by applying and sintering a conductive paste on the ceramic main body 100, or by plating. In addition, the first external electrode 200 and the second external electrode 300 may be formed by applying a conductive paste on the dielectric green sheet laminate and then sintering the conductive paste together with the dielectric green sheet laminate.

Hereinafter, specific examples of the present disclosure are described.

### [Manufacture of Multilayer Ceramic Capacitor]

### (Manufacturing Method of Example)

A dielectric paste containing barium titanate (BaTiO₃) powder was applied on the carrier film and then dried to prepare a plurality of dielectric green sheets with a thickness of 1.8 μm. A PVB binder of 10 wt % or more and 30 wt % or less based on the weight of the ceramic was contained in the dielectric paste, and the glass transition temperature (Tg) of the PVB binder was 85° C.

A conductive paste containing nickel was applied on the dielectric green sheet using a screen printing method.

About 100 layers of dielectric green sheets coated with conductive paste were stacked, and 5 layers of dielectric green sheets not coated with conductive paste were stacked on top and bottom, respectively, to manufacture a dielectric green sheet laminate.

The dielectric green sheet laminate was subjected to isostatic pressing at 85° C. and a pressure of 1000 kgf/cm².

The pressed dielectric green sheet laminate was cut into individual chips and then maintained at 230° C. for 60 hours in an air atmosphere to perform binder removal.

Then, it was sintered in a reducing atmosphere under an oxygen partial pressure of 10⁻¹¹ atm to 10⁻¹⁰ atm, which was lower than the Ni/NiO equilibrium oxygen partial pressure, so that the internal electrode was not oxidized at 1200° C.

Next, a multilayer capacitor (L×W×T=3.2 mm×1.6 mm×1.6 mm) was manufactured through processes such as external electrode formation and plating.

### (Manufacturing Method of Comparative Example Group 1)

A dielectric paste including 10 wt % or more and 30 wt % or less of a PVB binder with a glass transition temperature (Tg) of 70° C. based on the weight of the ceramic was prepared. Except for this, a multilayer ceramic capacitor was manufactured by the same method as Example 1.

### (Manufacturing Method of Comparative Example Group 2)

A dielectric paste including 10 wt % or more and 30 wt % or less of a PVB binder with a glass transition temperature (Tg) of 75° C. based on the weight of the ceramic was prepared. Except for this, a multilayer ceramic capacitor was manufactured by the same method as Example 1.

### [Moisture Resistance Load Test]

After respectively manufacturing a plurality of multilayer ceramic capacitors according to Example and Comparative Example Group 1 and Example and Comparative Example Group 2, the angles of the first exterior angle thereof were measured. Most of the angles of the first exterior angles of Example were included in the range of 18° to 20°. In addition, most of the angles of the first exterior angles of Comparative Example Group 1 were included in the range of 15° to 17°, and most of the angles of the first exterior angles of Comparative Example Group 2 were included in the range of 21° to 23°.

1,200 multilayer ceramic capacitors manufactured according to Example were each selected as Example 1, Example 2, and Example 3 according to the angle of the first exterior angle.

1,200 multilayer ceramic capacitors manufactured by Comparative Example Group 1 were each selected as Comparative Example 1, Comparative Example 2, and Comparative Example 3 according to the angle of the first exterior angle.

1,200 multilayer ceramic capacitors manufactured by Comparative Example Group 2 were each selected as Comparative Example 4, Comparative Example 5, and Comparative Example 6 according to the angle of the first exterior angle.

A moisture resistance load test was performed on the multilayer ceramic capacitors of Example 1 to Example 3 and Comparative Example 1 to Comparative Example 6 classified as above.

The moisture resistance load test was performed as follows.

First, three substrates were prepared for each classification of multilayer ceramic capacitors classified as above. 400 multilayer ceramic capacitors belonging to the same classification were mounted on each substrate.

Under conditions of 85° C. and 85% humidity, a current of 6.3 V was applied to each substrate for 8 hours. The number of failed multilayer ceramic capacitors was checked using the 8585 moisture resistance equipment (the 8585 moisture resistant equipment displays a signal when a deteriorating chip is detected, so it is possible to check whether there are multilayer ceramic capacitors that fail the moisture resistant load test).

The above experimental results were summarized and shown in Table 1.

TABLE 1

| | Angle of first | Moisture resistance |
|---|---|---|
| | exterior angle | test Number |
| | (°) | of failures |
| Comparative Example 1 | 15 | 4/1200 |
| Comparative Example 2 | 16 | 2/1200 |
| Comparative Example 3 | 17 | 2/1200 |
| Example 1 | 18 | 0/1200 |
| Example 2 | 19 | 0/1200 |
| Example 3 | 20 | 0/1200 |
| Comparative Example 4 | 21 | 1/1200 |
| Comparative Example 5 | 22 | 2/1200 |
| Comparative Example 6 | 23 | 2/1200 |

As shown in Table 1, all multilayer ceramic capacitors with an angle of 18° or more and 20° or less of the first exterior angle have passed the moisture resistance test criteria. In contrast, capacitors that did not pass the moisture resistance test criteria were observed when the angle of the first exterior angle was less than 18° or greater than 20°.

As described above, according to the multilayer ceramic capacitor of the present disclosure, an inclination of 18° or more and 20° or less is formed in the side area of the first cover layer, so that the moisture penetration path to the internal electrode may be blocked. Accordingly, the moisture resistance reliability of the multilayer ceramic capacitor may be improved.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A multilayer ceramic capacitor comprising:
a dielectric layer;
a first internal electrode and a second internal electrode facing each other with the dielectric layer interposed therebetween; and
a first cover layer disposed over at least one of the first internal electrode and the second internal electrode,
wherein the first cover layer includes a center area and a side area disposed outside of the center area, and
the side area has a surface inclined toward an edge of the dielectric layer at an inclination of 18° or more and 20° or less with respect to a surface of the center area.

2. The multilayer ceramic capacitor of claim 1, wherein
the side area is disposed to surround the center area.

3. The multilayer ceramic capacitor of claim 1, wherein
the multilayer ceramic capacitor includes an active area,
the first internal electrode and the second internal electrode overlap each other in the active area, and
the center area is disposed over the active area.

4. The multilayer ceramic capacitor of claim 3, wherein
the multilayer ceramic capacitor further includes a margin area,
the margin area surrounds the active area, and
the side area is disposed over the margin area.

5. The multilayer ceramic capacitor of claim 4, wherein
the center area does not overlap the margin area, and
the side area does not overlap the active area.

6. The multilayer ceramic capacitor of claim 1, wherein
the surface of the side area is inclined with respect to an extension line of an uppermost internal electrode among the first internal electrode and the second internal electrode.

7. The multilayer ceramic capacitor of claim 1, further comprising
a second cover layer disposed on the dielectric layer, the first internal electrode, and the second internal electrode,
wherein the dielectric layer, the first internal electrode, and the second internal electrode are between the first cover layer and the second cover layer, and
wherein a portion of the second cover layer overlapping the side area is at the inclination with respect to a line parallel to the side area.

8. A method of manufacturing the multilayer ceramic capacitor of claim 1, comprising:
applying a paste on a film to form a dielectric green sheet, wherein the paste includes polyvinyl butyral that has a glass transition temperature of 80° C. or higher and 90° C. or lower.

9. The method of claim 8, wherein the paste further includes a ceramic, and the paste includes polyvinyl butyral in an amount of 10 wt % or more and 30 wt % or less based on a weight of the ceramic.

10. The method of claim 8, further comprising:
applying a conductive paste including a conductive metal onto a surface of the dielectric green sheet,
stacking a plurality of the dielectric green sheets on which the conductive paste was applied to form a laminate, and
sintering the laminate to form the dielectric layer, the first internal electrode, and the second electrode.
